(19) United States
(12) Patent Application Publication
(10) Pub. No.: US 2022/0266522 A1
(43) Pub. Date: Aug. 25, 2022

(54) IN SITU THERMO ACOUSTIC NON-DESTRUCTIVE TESTING DURING THREE-DIMENSIONAL PRINTING

(71) Applicant: PALO ALTO RESEARCH CENTER INCORPORATED, PALO ALTO, CA (US)

(72) Inventors: WARREN JACKSON, SAN FRANCISCO, CA (US); KENT EVANS, CUPERTINO, CA (US)

(21) Appl. No.: 17/183,058

(22) Filed: Feb. 23, 2021

(51) Int. Cl. B29C 64/386; G01N 21/17; G01N 21/88; G01N 25/72; G01N 29/04; B29C 64/273

(52) U.S. Cl. CPC B29C 64/386; G01N 21/1702; G01N 21/8806; G01N 25/72; G01N 29/043; B29C 64/273; G01N 2021/1706; G01N 2201/06113

(57) ABSTRACT

An apparatus has an additive manufacturing system configured to deposit material in layers to form a three-dimensional object on a surface, an energy source positioned adjacent the object positioned such that energy from the source reaches the object, a detector to receive energy reflected from the object, and a controller configured to activate the energy source and receive signals from the detector as each layer is deposited. A method of monitoring an additive manufacturing process includes depositing material in a layer on a surface to form a three-dimensional object, activating an energy source located adjacent the surface, detecting reflections of the energy from the object, analyzing the reflections to determine an integrity of the object, and providing a notification when the integrity of the object does not meet a threshold.

### TECHNICAL FIELD

This disclosure relates to three-dimensional printing, more particularly to testing during the process of three-dimensional printing.

### BACKGROUND

Current processes to detect defects in parts made by additive manufacturing have some issues. The term “additive manufacturing” means processes used to build parts in a layer-by-layer fashion, such as three-dimensional (3D) printing, and selective laser sintering (SLS), etc. Detecting defects in the parts typically requires expensive non-destructive testing, such as thermal or acoustic imaging and x-rays. Further, the testing generally occurs after manufacture of the part.

If the testing detects defects, the manufacturer typically has to scrap the completed part, increasing the costs. Further, in some instances, the after-manufacture testing does not detect problems, meaning that defective parts enter the market place. For example, x-rays often fail to detect cracks, so some parts with cracks may end up in the manufacturing flows for products in which that part will ultimately reside. Finally, some of these processes use up a lot of time, slowing down manufacturing, again increasing costs.

### SUMMARY

According to aspects illustrated here, there is provided an apparatus having an additive manufacturing system configured to deposit material in layers to form a three-dimensional object on a surface, an energy source positioned adjacent the object positioned such that energy from the source reaches the object, a detector to receive energy reflected from the object, and a controller configured to activate the energy source and receive signals from the detector as each layer is deposited.

According to aspects illustrated here, there is provided a method of monitoring an additive manufacturing process that includes depositing material in a layer on a surface to form a three-dimensional object, activating an energy source located adjacent the surface, detecting reflections of the energy from the object, analyzing the reflections to determine an integrity of the object, and providing a notification when the integrity of the object does not meet a threshold.

### BRIEF DESCRIPTION OF THE DRAWINGS

FIG. 1 shows a block diagram of an additive manufacturing system having an in-process monitoring system.

FIGS. 2-3 show embodiments of a monitoring system using at least one of thermal and acoustic waves.

FIGS. 4-6 show embodiments of a laser-based monitoring system.

### DETAILED DESCRIPTION OF THE EMBODIMENTS

The embodiments here employ an in-situ, or in process, monitoring system as part of the additive manufacturing system. As used here, the term “additive manufacturing” system means any manufacturing that deposits material to a surface to build a three-dimensional object in a layer-wise fashion. For example, in a 3D printing system, the system forms the object by depositing the material according to a print controller. The system deposits the material in a pattern for each layer, such that each layer builds upon the previous layer to form the object. In the case of a selective laser sintering systems, the material is deposited in the form of a powder bed in which a laser bonds the powder together for each layer. Powder is added to create the next layer and repeated until the object is formed. These examples merely serve to help with understanding the discussion and should not limit the scope of the embodiments.

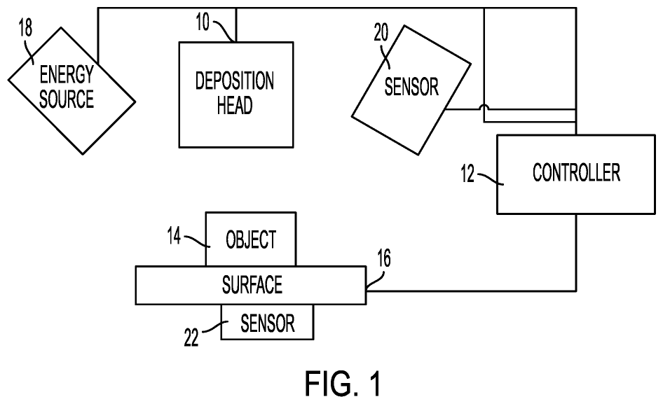

FIG. 1 shows a general block diagram of an additive manufacturing system with an in situ monitoring system. The system has a deposition head 10 under control of the controller 12. The deposition head 10 deposits material in layers to form an object such as 14 on a deposition surface 16. The deposition surface 16 may comprise a movable stage that moves from right to left across the figure. In some embodiments, the monitoring system may monitor the object during deposition, or immediately after deposition. In the embodiment shown, the system monitors the object as the deposition layer is formed.

An energy source 18 directs a form of energy, such as heat or light, towards the object in modulated waves or as discrete pulses. The sensor 20 detects alterations in the waves caused by deformities in the object, such as cracks. In addition to the sensor 20, a vibration sensor 22 may also connect to the controller 12. The sensor 22 may have a frequency response range that include the actuation range, such as between 10-100 kHz. The controller 12 can either adjust operation of the deposition head as the layers are being deposited, or can make the determination that the part needs to be scrapped.

In some embodiments, the controller that controls the deposition head and the controller that manages the in situ monitoring systems may be the same controller or may be embodied in different controllers. If they operate as separate controllers, the system may include some way of communicating any issues detected by the monitoring system controller. This may involve a direct link between the two controllers, a simple message to the user running the machine, or any other method. The monitoring system controller, whether it also acts as the deposition system controller or not, actives the energy source and receives the readings from the detector.

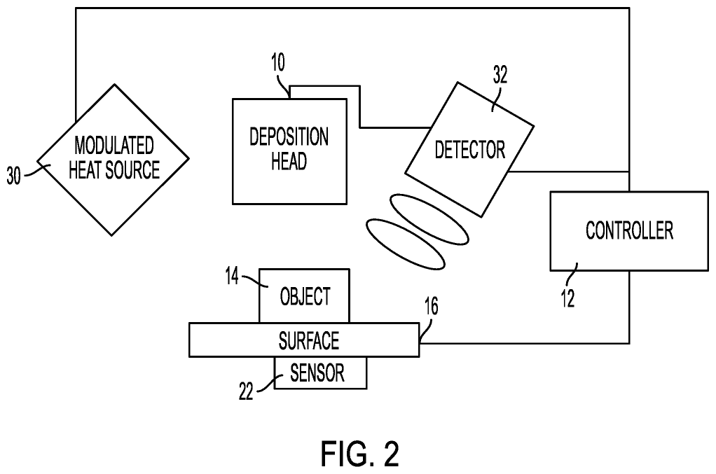

In some embodiments, the energy source comprises a time-varying energy source that can generate thermal waves and the detector comprises a temperature sensor. FIG. 2 shows an embodiment of such a system. The modulated heat source 30 generates waves of thermal energy directed to the object 14 as the deposition head 10 deposits each layer of material on the surface 16. Defects in the object alter the propagating acoustic and/or thermal waves and the difference in the waves received by the detector 32, which may comprises temperature detector. A vibration sensor such as 22 may detect alterations in the acoustic waves.

Thermal waves that function as oscillatory temperature waves generally have the profile of:

$${T}_{a c} ( x , t ) = Re [ \frac{{I}_{o}}{2 {K}_{q}} {e}^{- qx} {e}^{i ω t} ] = \frac{{I}_{o}}{2 ε \sqrt{ω}} {e}^{\frac{- x}{μ}} cos ( \frac{x}{μ} - ω t + \frac{π}{4} ) ,$$

where ϵ=K/√D, μ=(2D/ω)^{1/2}, and K=ρcD. In the embodiment applied to Al for example, D=0.97 cm²/s, and ρ=2.7 g/cm³. The thermal modulation depth, μ decreases with increased frequency. Therefore, in all the embodiments, variation of the modulation frequency can be used to examine material quality as a function of depth.

This system can monitor material quality during printing and provide real-time feedback during the print process. As mentioned before, the system may alter the deposition process to correct for further defects, or it may shut the print down before wasting further material. The surface 16 may translate from right to left relative to the figure, or the detection system may move. The controller may alter the frequency of the thermally generated acoustic waves to allow depth profiling of the object. Layer-by-layer differential imaging may provide a more accurate determination.

In another embodiment, using a system configuration as in FIG. 2. However, the modulated heat source 30 in this embodiment, the modulated heat source comprises a modulated eddy current heat source and the detector 32 comprises an IR detector/thermal imager. The imager may include one or more lenses. The power to power the imager and the heat source may be split off from the print head. In another embodiment, the IR detector may track the thermal signature as the object cools down.

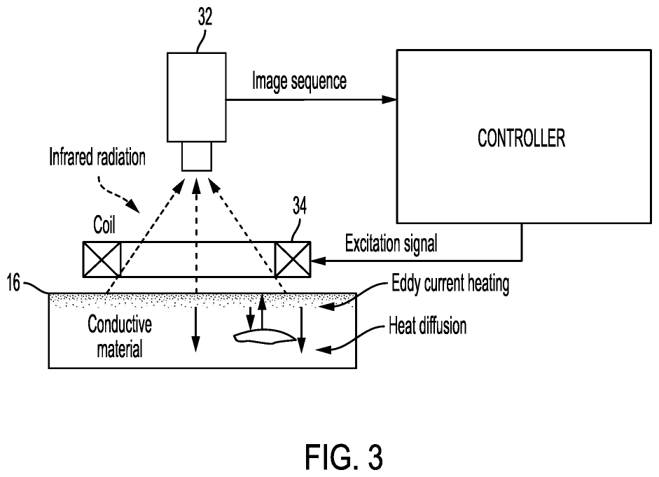

FIG. 3 shows another embodiment using coaxial generators and detectors, or just a detector with the generator in the surface. One embodiment may use an eddy current heater in the surface. In this embodiment the surface contains conductive material. The controller generates an excitation signal, possibly through a coil 34. This generates infrared radiation, picked up by detector 32, in this case an IR camera. The camera sends the image sequence to the controller for analysis.

In embodiments, the detector or IR camera may also have an arc lamp or other energy source mounted with it, and the IR camera picks up the resulting heat signature. In yet another embodiment, the detector 32 is a confocal height detector sensor that may already reside on the printer. A confocal sensor, as that term is used here, generates polychromatic light focused on the object, not shown in FIG. 3, and the reflected light is focused back into a detector. The collection efficiency is very sensitive to the surface height which is modulated by the thermal expansion caused by the modulated heat source.

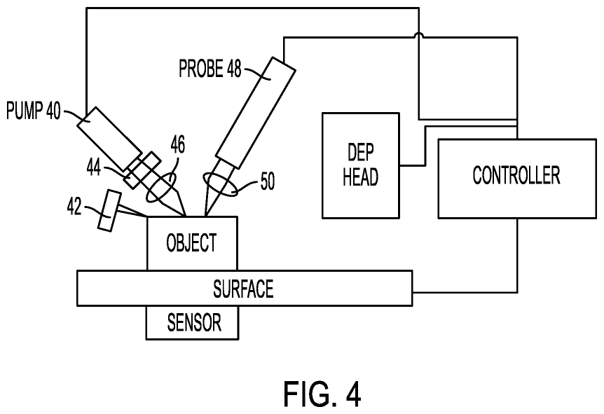

FIGS. 4-6 show other embodiments using photoacoustic vibration and thermal wave generation and detection. The system of FIG. 1 is adapted to include a pump laser 40 and a probe laser 48. In the embodiment of FIG. 4, the pump laser 40 creates point source of stress and temperature waves. A modulator 44 allows modulation of the energy. The pump laser system may include at last one lens such as 46. The thermal and vibration waves are scattered by imperfections such as cracks. Temperature waves do not propagate and produced by low-frequency modulation. Vibrations do propagate and produced by high-frequency modulation. The probe laser 48 measures the reflected vibrations and temperatures waves by changes in position of the probe laser using the position sensor 42. The vibration sensor may measure transmitted vibrations.

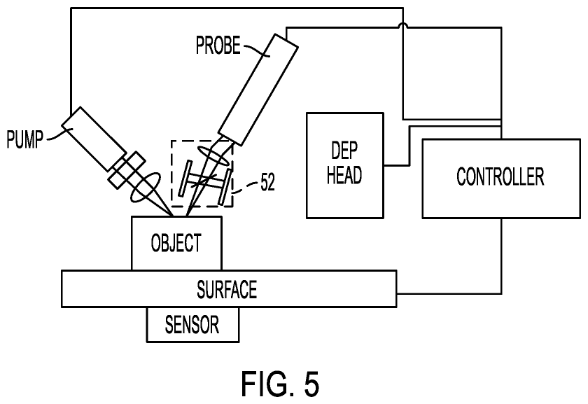

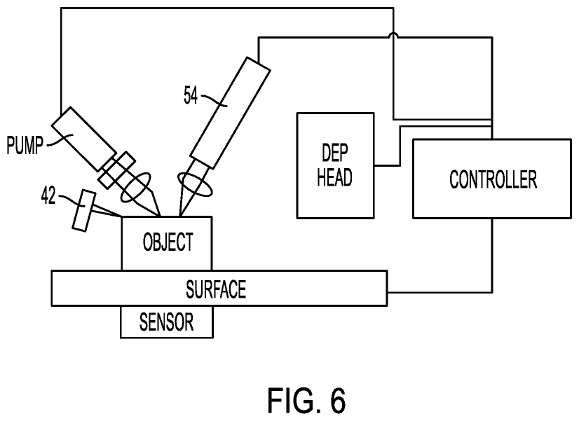

FIG. 5 shows an embodiment of a system similar to FIG. 4 but includes an interferometer 52. The interferometer measures the reflected vibrations and temperature waves. In FIG. 6, an IR detector 54 replaces the probe laser. The position sensor 42 allows measuring the reflected vibrations and temperature by changes in position of probe laser.

Any of the above embodiments, and any combination of any of the components set out above may be used in a method to monitor an additive manufacturing process. The process deposits material in a layer on a surface to form a three-dimensional object. The controller activates the energy source located adjacent the surface, including confocally located with the detector. The detector then detects reflections of the energy from the object. The controller then analyzes the reflections to determine an integrity of the object. The system then provides a notification to the system when the integrity of the object is deemed to be comprised. This may include comparing the detected reflected energy to an ideal signal and determining that the reflected energy has varied from the ideal signal by too high of a threshold.

In this manner, an additive manufacturing system can detect and respond to defects occurring in objects being manufactured. The system can either adjust operation of the system to eliminate the issue causing the defects, or to attempt to ‘cure’ the defect, or can shut down production. The latter saves the cost of materials that would otherwise go to waste if the manufacturing continues and results in a defective part.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus, comprising:
an additive manufacturing system configured to deposit material in layers to form a three-dimensional object on a surface;
an energy source positioned adjacent the object positioned such that energy from the source reaches the object;
a detector to receive energy reflected from the object; and
a controller configured to activate the energy source and receive signals from the detector as each layer is deposited.

2. The apparatus as claimed in claim 1, wherein the energy source comprises a time-varying energy source to generate thermal waves and the detector comprises a temperature sensor.

3. The apparatus as claimed in claim 1, wherein the energy source comprises a time-varying energy source to generate acoustic waves and the detector comprises an acoustic sensor.

4. The apparatus as claimed in claim 1, wherein the energy source is a frequency modulated energy source.

5. The apparatus as claimed in claim 1, wherein the energy source is a pulsed energy source.

6. The apparatus as claimed in claim 1, wherein the energy source comprises a modulated eddy current heat source and the detector comprises an infrared detector.

7. The apparatus as claimed in claim 1, wherein the energy source comprises one of an eddy current heat source or a heat lamp and the detector comprises a confocal height monitor.

8. The apparatus as claimed in claim 1, wherein the energy source comprises heat source coil and the detector comprises one of either an infrared camera or confocal camera.

9. The apparatus as claimed in claim 1, wherein the energy source comprises a pump laser and the detector comprises a probe laser.

10. The apparatus as claimed in claim 9, wherein the detector further comprises a vibration sensor.

11. The apparatus as claimed in claim 9, wherein the detector further comprises a position sensor.

12. The apparatus as claimed in claim 9, wherein the detector further comprises an interferometer.

13. The apparatus as claimed in claim 9, wherein the detector further comprises an infrared detector.

14. A method of monitoring an additive manufacturing process, comprising:
depositing material in a layer on a surface to form a three-dimensional object;
activating an energy source located adjacent the surface;
detecting reflections of the energy from the object;
analyzing the reflections to determine an integrity of the object; and
providing a notification when the integrity of the object does not meet a threshold.

15. The method as claimed in claim 14, wherein activating an energy source comprises activating one of a flash lamp, an arc lamp, an eddy current generator, and a pump laser source

16. The method as claimed in claim 14, wherein detecting reflections comprises using one of a temperature sensor, a vibration sensor, an infrared detector, an infrared camera, a confocal sensor, and a probe laser.

17. The method as claimed in claim 14, wherein detecting reflections comprises using a probe laser.

18. The method as claimed in claim 17, wherein detecting reflections includes using a position sensor on the probe laser.

19. The method as claimed in claim 17, wherein using a probe laser includes using an interferometer to measure vibrations and temperature waves.

20. The method as claimed in claim 17, wherein activating an energy source comprises activating a pump laser and further comprising modulating the laser.
